(19) United States
(12) Patent Application Publication
(10) Pub. No.: US 2019/0081938 A1
(43) Pub. Date: Mar. 14, 2019

(54) INFORMATION PROCESSING APPARATUS, ACCESS CONTROL SYSTEM, AND NON-TRANSITORY COMPUTER READABLE MEDIUM

(71) Applicant: FUJI XEROX CO., LTD., Tokyo (JP)

(72) Inventors: Kei OTSU, Kanagawa (JP); Kazuhito FUJIKAWA, Kanagawa (JP)

(73) Assignee: FUJI XEROX CO., LTD., Tokyo (JP)

(21) Appl. No.: 16/111,885

(22) Filed: Aug. 24, 2018

(30) Foreign Application Priority Data
Sep. 8, 2017 (JP) 2017-172694

(51) Int. Cl. H04L 29/06

(52) U.S. Cl. CPC H04L 63/08; H04L 63/101

(57) ABSTRACT

An information processing apparatus includes an authentication data sender, an authenticator, a display, and an operation receiver. The authentication data sender sends authentication data to a subject terminal apparatus. The authentication data is used for granting a temporary access right to temporarily access content. The authenticator authenticates the subject terminal apparatus by using a representation based on the authentication data displayed on the subject terminal apparatus. The display displays an image of a user of the subject terminal apparatus. The image is obtained by using an imaging apparatus to which the information processing apparatus is connectable via a network. The operation receiver receives an operation performed by an operator of the information processing apparatus to grant the temporary access right.

### CROSS-REFERENCE TO RELATED APPLICATIONS

This application is based on and claims priority under 35 USC 119 from Japanese Patent Application No. 2017-172694 filed Sep. 8, 2017.

### BACKGROUND

### Technical Field

The present invention relates to an information processing apparatus, an access control system, and a non-transitory computer readable medium.

### SUMMARY

According to an aspect of the invention, there is provided an information processing apparatus including an authentication data sender, an authenticator, a display, and an operation receiver. The authentication data sender sends authentication data to a subject terminal apparatus. The authentication data is used for granting a temporary access right to temporarily access content. The authenticator authenticates the subject terminal apparatus by using a representation based on the authentication data displayed on the subject terminal apparatus. The display displays an image of a user of the subject terminal apparatus. The image is obtained by using an imaging apparatus to which the information processing apparatus is connectable via a network. The operation receiver receives an operation performed by an operator of the information processing apparatus to grant the temporary access right.

### BRIEF DESCRIPTION OF THE DRAWINGS

An exemplary embodiment of the present invention will be described in detail based on the following figures, wherein:

FIG. 1 illustrates an example of an access control system utilizing the exemplary embodiment;

FIG. 2 illustrates a hardware configuration of each of a content management server, an authenticated terminal apparatus, an unauthenticated terminal apparatus, and an imaging apparatus;

FIG. 3 illustrates an example of content information managed by an access manager of the content management server;

FIG. 4 illustrates an example of imaging apparatus information managed by the access manager of the content management server;

FIG. 5 illustrates an example of temporary access information managed by the access manager of the content management server;

FIG. 6 is a sequence diagram illustrating an access request made by an authenticated terminal apparatus and a response to this access request returned from a content management server;

FIG. 7 is a sequence diagram illustrating a temporary access request made by an unauthenticated terminal apparatus and a response to this temporary access request;

FIG. 8 is a flowchart illustrating an example of an authentication data generating routine;

FIG. 9A illustrates an example of a dialog box displayed on the authenticated terminal apparatus when a temporary access request is received;

FIG. 9B illustrates an example of a dialog box displayed on the authenticated terminal apparatus for selecting an imaging apparatus;

FIG. 10 is a flowchart illustrating an example of an authentication data display routine;

FIG. 11A illustrates an example of a dialog box displayed on the unauthenticated terminal apparatus when authentication data is received;

FIG. 11B illustrates an example of a dialog box displayed on the unauthenticated terminal apparatus based on authentication data;

FIG. 12 is a flowchart illustrating an example of an unauthenticated terminal apparatus authenticating routine;

FIG. 13 is a flowchart illustrating an example of a requester authenticating routine;

FIG. 14A illustrates an example of a dialog box displayed on the authenticated terminal apparatus when the unauthenticated terminal apparatus is authorized; and

FIG. 14B illustrates an example of a dialog box displayed on the authenticated terminal apparatus with an image of a requester of a temporary access request for checking the requester.

### DETAILED DESCRIPTION

An exemplary embodiment of the invention will be described below in detail with reference to the accompanying drawings.

### [Access Control System 1]

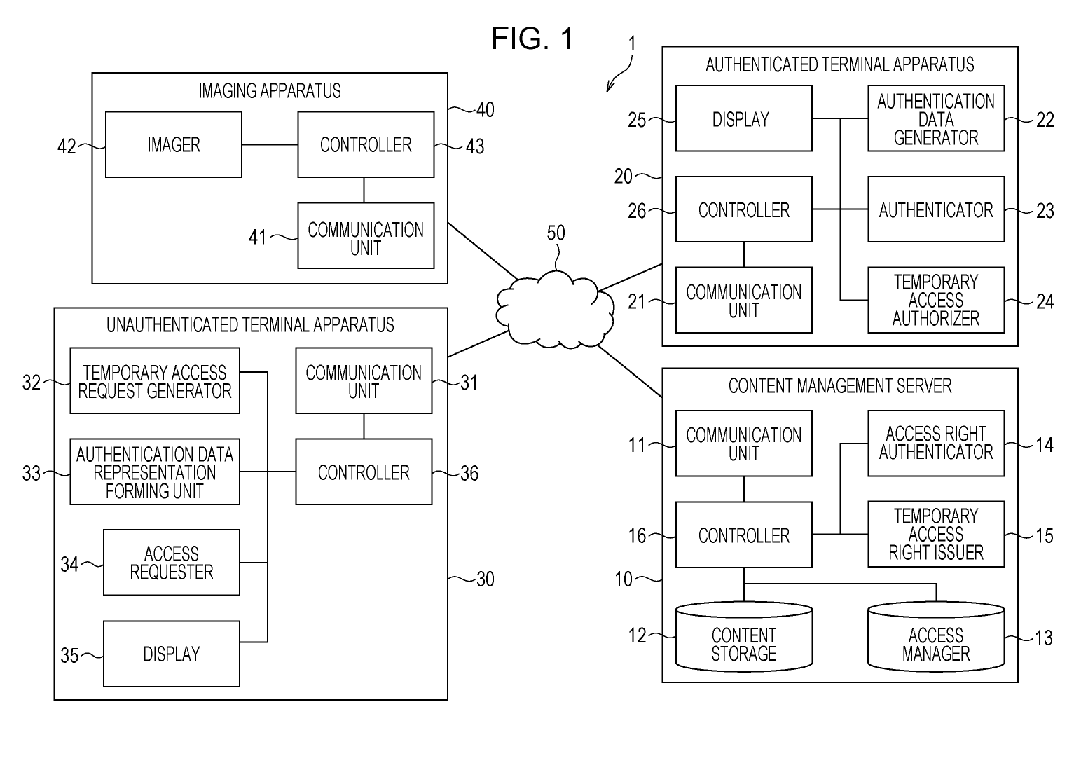

FIG. 1 illustrates an example of an access control system 1 utilizing the exemplary embodiment. The access control system 1 includes a content management server 10, an authenticated terminal apparatus 20, an unauthenticated terminal apparatus 30, and an imaging apparatus 40. The content management server 10, the authenticated terminal apparatus 20, the unauthenticated terminal apparatus 30, and the imaging apparatus 40 are connected to each other via a network 50. The authenticated terminal apparatus 20 is an example of an information processing apparatus and an example of a first terminal apparatus. The unauthenticated terminal apparatus 30 is an example of a subject terminal apparatus to be authenticated and an example of a second terminal apparatus.

An overview of the content management server 10, the authenticated terminal apparatus 20, the unauthenticated terminal apparatus 30, and the imaging apparatus 40 will first be described below.

The content management server 10 stores and manages content so that authorized users (users with an access right) are allowed to access the content and unauthorized users (users without an access right) are not allowed to access the content. The security level (confidentiality) of some content is high, and it is necessary to prevent such content from leaking or being viewed by unauthorized users.

In some cases, however, an unauthorized user is required to temporarily access such content. For example, an authorized user and an unauthorized user attend the same meeting and are requested to share and check the same content. In other cases, a request may be made from an unauthorized user to temporarily access the content. In such cases, an access right is temporarily granted to this unauthorized user. If the unauthorized user is located away from an authorized user (user to grant an access right), it is not easy to check (verify) the identity of the unauthorized user. If unauthorized access, such as spoofing, is made, the content may leak to the outside.

“Security” means protecting content from a leakage and unauthorized access to maintain the confidentiality of the content.

In this exemplary embodiment, when the unauthenticated terminal apparatus 30, which has not been authenticated by the content management server 10 in advance, has sent a request to temporarily access content managed by the content management server 10 to the authenticated terminal apparatus 20 (such a request will also be called a temporary access request), the authenticated terminal apparatus 20 first authenticates the unauthenticated terminal apparatus 30 by using the imaging apparatus 40 to which the authenticated terminal apparatus 20 is connectable (first authentication). Then, the authenticated terminal apparatus 20 authenticates the user of the unauthenticated terminal apparatus 30, that is, the user having sent the temporary access request (requester), by using the imaging apparatus 40 that can image the user (second authentication). That is, two stages of authentication by using the imaging apparatus 40, authentication of the unauthenticated terminal apparatus 30 and authentication of the identity of the requester, are conducted, thereby enhancing the security level.

The meaning of “temporary” is that, after a user has sent a temporary access request, authentication conducted for this user and the unauthenticated terminal apparatus 30 of the user is canceled when such access has been completed. If the user sends a request to access the content again, authentication is required again for this user and the unauthenticated terminal apparatus 30.

Content is digital data, such as documents, drawings, photos, music, sound, video (video images), programs, and data, and is stored in a storage device (content storage 12, which will be discussed later). Managing of content refers to that a condition for accessing this content is set, and a user satisfying this condition has an access right and is allowed to access the content. To access content is to use the content. If content is a document, a drawing, a photo, a program, or data, accessing this content is reading, editing, and processing the content. If content is music, sound, video (video images), accessing this content is viewing and listening, editing, and processing the content.

The authenticated terminal apparatus 20 is a terminal which has been authenticated by the content management server 10 in advance. A user (operator) operating the authenticated terminal apparatus 20 is a manager or a creator of content managed by the content management server 10, and has a right to access the content (access right). The operator may alternatively be allowed to access the content as a result of being authenticated by the content management server 10. The operator of the authenticated terminal apparatus 20 is authorized to grant a temporary access right in response to a temporary access request from the unauthenticated terminal apparatus 30. This will be discussed in detail later.

The unauthenticated terminal apparatus 30 is a terminal which has not been authenticated by the content management server 10 in advance. A requester of the unauthenticated terminal apparatus 30 sends a request to access content managed by the content management server 10 to the authenticated terminal apparatus 20. As a result of obtaining an access right, the unauthenticated terminal apparatus 30 is able to temporarily access the content. In this case, the authenticated terminal apparatus 20 and the unauthenticated terminal apparatus 30 may share the same content.

The imaging apparatus 40 is located near the unauthenticated terminal apparatus 30. The imaging apparatus 40 is connected to the authenticated terminal apparatus 20 via the network 50. The authenticated terminal apparatus 20 can operate the imaging apparatus 40 via the network 50 so as to view and check (verify) images captured by the imaging apparatus 40.

To enhance the security level, the imaging apparatus 40 is desirably fixed in a predetermined location. That is, restricting of the location where the unauthenticated terminal apparatus 30 accesses content can increase the security level. In this exemplary embodiment, it is assumed that the imaging apparatus 40 is fixed in a predetermined location.

The imaging apparatus 40 may be a camera used in a video conference system, a camera integrated in a display device (monitor), or a desktop camera.

The network 50 may be any type of communication line that can send and receive digital data. The network 50 may be a dedicated communication network or the Internet through which data can be sent and received to and from devices that are identified by Internet Protocol (IP) addresses (including the content management server 10, the authenticated terminal apparatus 20, the unauthenticated terminal apparatus 30, and the imaging apparatus 40).

The functional configurations of the content management server 10, the authenticated terminal apparatus 20, the unauthenticated terminal apparatus 30, and the imaging apparatus 40 will be discussed below in this order.

The content management server 10 includes a communication unit 11, a content storage 12, an access manager 13, an access right authenticator 14, a temporary access right issuer 15, and a controller 16. The communication unit 11 serves as an interface with the network 50. The content storage 12 stores content. The access manager 13 manages access to content. The access right authenticator 14 authenticates an access right to access content. The temporary access right issuer 15 grants a temporary access right for content. The controller 16 controls the communication unit 11, the content storage 12, the access manager 13, the access right authenticator 14, and the temporary access right issuer 15.

The authenticated terminal apparatus 20 includes a communication unit 21, an authentication data generator 22, an authenticator 23, a temporary access authorizer 24, a display 25, and a controller 26. The communication unit 21 serves as an interface with the network 50. The authentication data generator 22 generates authentication data in response to a temporary access request from the unauthenticated terminal apparatus 30. The authenticator 23 authenticates the unauthenticated terminal apparatus 30 based on the authentication data sent to the unauthenticated terminal apparatus 30. The temporary access authorizer 24 authorizes a temporary access. The display 25 displays data and content for performing access control. The controller 26 controls the communication unit 21, the authentication data generator 22, the authenticator 23, the temporary access authorizer 24, and the display 25. The communication unit 21, the authentication data generator 22 are an example of an authentication data sender, and the temporary access authorizer 24 is an example of an operation receiver.

The unauthenticated terminal apparatus 30 includes a communication unit 31, a temporary access request generator 32, an authentication data representation forming unit 33, an access requester 34, a display 35, and a controller 36. The communication unit 31 serves as an interface with the network 50. The temporary access request generator 32 generates a temporary access request to temporarily access content managed by the content management server 10. The authentication data representation forming unit 33 forms a representation based on authentication data received from the authenticated terminal apparatus 20. The access requester 34 sends an access request to the content management server 10. The display 35 displays a representation based on authentication data received from the authenticated terminal apparatus 20 and content received from the content management server 10. The controller 36 controls the communication unit 31, the temporary access request generator 32, the authentication data representation forming unit 33, the access requester 34, and the display 35.

The imaging apparatus 40 includes a communication unit 41, an imager 42, and a controller 43. The communication unit 41 serves as an interface with the network 50. The imager 42 performs image capturing. The controller 43 controls the communication unit 41 and the imager 42. The imaging apparatus 40 may be any type of apparatus that is disposed near the unauthenticated terminal apparatus 30 and can capture at least the image of a requester having sent a temporary access request by using the unauthenticated terminal apparatus 30. In this example, the imaging apparatus 40 can also capture the image of a representation based on authentication data displayed on the display 35 of the unauthenticated terminal apparatus 30. Images captured by the imager 42 include still images and video images.

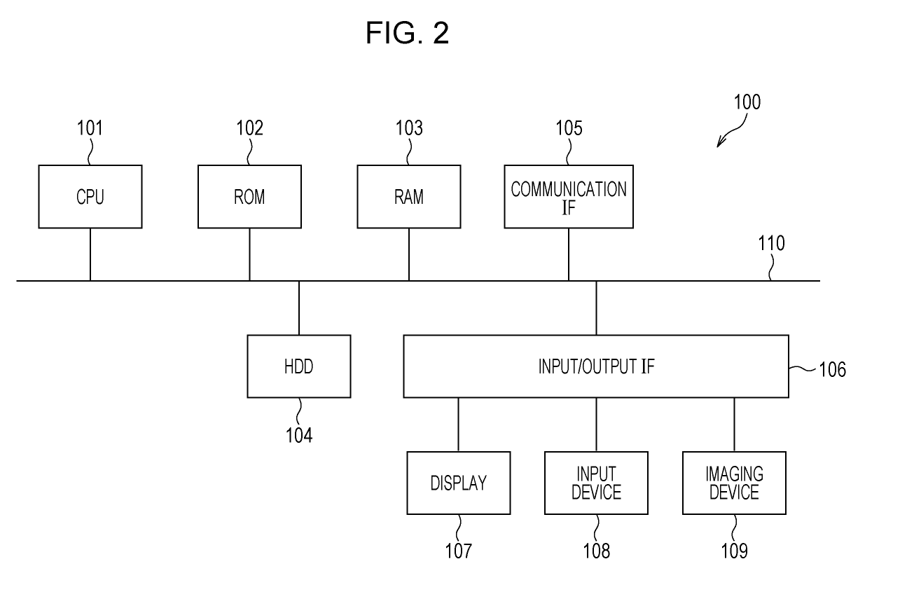

FIG. 2 illustrates a hardware configuration 100 of each of the content management server 10, the authenticated terminal apparatus 20, the unauthenticated terminal apparatus 30, and the imaging apparatus 40.

The hardware configuration 100 includes a central processing unit (CPU) 101, a read only memory (ROM) 102, a random access memory (RAM) 103, a hard disk drive (HDD) 104, a communication input/output interface (communication IF) 105, an input/output IF 106, a display 107 connected to the input/output IF 106, an input device 108 connected to the input/output IF 106, an imaging device 109 connected to the input/output IF 106, and a bus 110.

The ROM 102 is a non-volatile memory that can retain stored (written) data even without power supply. Examples of the ROM 102 are an erasable programmable read only memory (EPROM), electrically erasable programmable read only memory (EEPROM), and a flash memory. The ROM 102 stores application software (programs) for operating the content management server 10, the authenticated terminal apparatus 20, and the unauthenticated terminal apparatus 30. The ROM 102 also stores data concerning initial values of the constants and variables used by the programs.

The RAM 103 is a volatile memory that requires power to retain stored data. When power is interrupted, data stored in the RAM 103 is lost. The RAM 103 can store a greater amount of data than the ROM 102 and can read and write more quickly than the ROM 102. An example of the RAM 103 is a dynamic random access memory (DRAM). Programs and data stored in the ROM 120 are read out to the RAM 103 and are loaded and written into the RAM 103 so that they can be executed. The RAM 103 is also used as a work area for storing data for operating the content management server 10, the authenticated terminal apparatus 20, and the unauthenticated terminal apparatus 30.

The HDD 104 is a rewritable non-volatile memory that can retain stored (written) data even without power supply. The HDD 104 can store a large amount of data.

The communication IF 105 is an interface with the network 50 shown in FIG. 1.

The input/output IF 106 is connected to the display 107, the input device 108, and the imaging device 109. The display 107 is a liquid crystal display (LCD), for example, which allows a user to view images on the display 107. The input device 108 is a device used by an operator (user) to provide instructions to the CPU 101, and may include a keyboard, a touchscreen, and a switch. The imaging device 109 is a device which captures images (still images and video images), and is a camera. The camera may be constituted by an imaging device, such as a charge-coupled device (CCD) or a complementary metal-oxide semiconductor (CMOS).

The bus 110 is connected to the CPU 101, the ROM 102, the RAM 103, the HDD 104, the communication IF 105, and the input/output IF 106, and allows the CPU 101 to input and output programs and data.

When power is supplied, the CPU 101 reads programs and data stored in the ROM 102 and loads and writes them to the RAM 103 so that it can execute the programs by using data. The CPU 101 then executes the programs in a predetermined order. When executing the programs, the CPU 101 sends and receives data to and from the HDD 104, the communication IF 105, and the input/output IF 106.

Some of the ROM 102, the RAM 103, and the HDD 104 may be replaced by a rewritable non-volatile memory, such as a flash memory. Additionally, the ROM 102 and the RAM 103 may be integrally formed with the CPU 101. In this case, the ROM 102 and the RAM 103 may be constituted by a flash memory.

When the hardware configuration 100 represents the content management server 10 shown in FIG. 1, the association between the elements of the hardware configuration 100 and those of the content management server 10 is as follows. The CPU 101, the ROM 102, and the RAM 103 form the access right authenticator 14, the temporary access right issuer 15, and the controller 16. The HDD 104 forms the content storage 12 and the access manager 13. The communication IF 105 forms the communication unit 11. The provision of the display 107 or the input device 108 in the content management server 10 may be omitted. The provision of the imaging device 109 in the content management server 10 may also be omitted. If the display 107, the input device 108, and the imaging device 109 are not provided, the provision of the input/output IF 106 may also be omitted.

When the hardware configuration 100 represents the authenticated terminal apparatus 20 shown in FIG. 1, the association between the elements of the hardware configuration 100 and those of the authenticated terminal apparatus 20 is as follows. The CPU 101, the ROM 102, and the RAM 103 form the authentication data generator 22, the authenticator 23, and the controller 26. The communication IF 105 forms the communication unit 21. The display 107 forms the display 25. The input device 108 forms the temporary access authorizer 24. The provision of the HDD 104 and the imaging device 109 in the authenticated terminal apparatus 20 may be omitted.

When the hardware configuration 100 represents the unauthenticated terminal apparatus 30 shown in FIG. 1, the association between the elements of the hardware configuration 100 and those of the unauthenticated terminal apparatus 30 is as follows. The CPU 101, the ROM 102, and the RAM 103 form the temporary access request generator 32, the authentication data representation forming unit 33, the access requester 34, and the controller 36. The communication IF 105 forms the communication unit 31. The display 107 forms the display 35. The provision of the HDD 104 and the imaging device 109 in the unauthenticated terminal apparatus 30 may be omitted.

When the hardware configuration 100 represents the imaging apparatus 40 shown in FIG. 1, the association between the elements of the hardware configuration 100 and those of the imaging apparatus 40 is as follows. The CPU 101, the ROM 102, and the RAM 103 form the controller 43. The communication IF 105 forms the communication unit 41. The imaging device 109 forms the imager 42. The provision of the HDD 104, the display 107, and the input device 108 in the imaging apparatus 40 may be omitted.

### (Content Stored in Content Storage 12 and Access Management Data Managed by Access Manager 13)

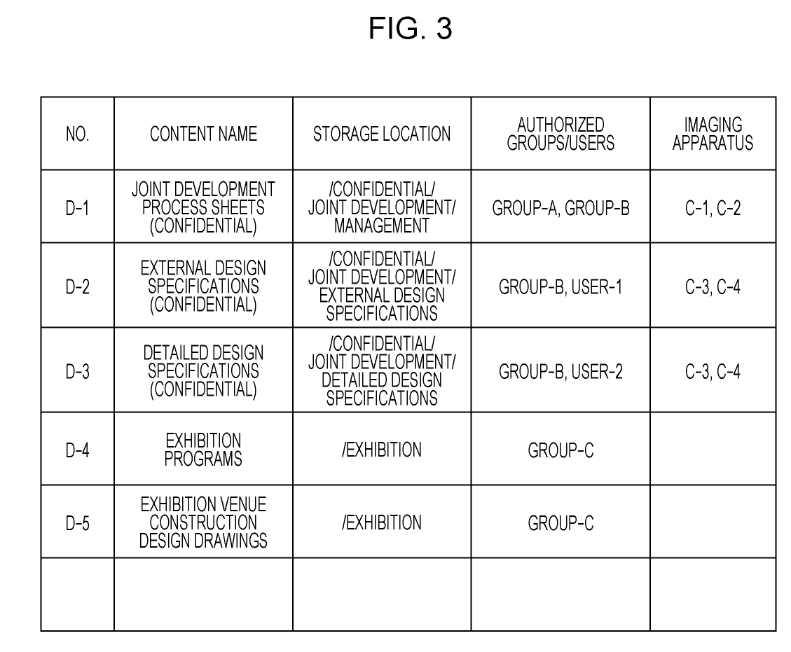

FIG. 3 illustrates an example of content information managed by the access manager 13 of the content management server 10. It is assumed that content stored in the content storage 12 is documents concerning a joint development product. Among the documents concerning the joint development product, joint development process sheets, external design specifications, and detailed design specifications are stored as confidential data, while exhibition programs for showing this product and exhibition venue construction design drawings are stored as open data.

The access manager 13 stores content information in association with the content number (No.), content name, storage location, authorized groups/users, and imaging apparatus (imaging apparatus 40). Group-A is a management group, for example, Group-B is a development group, for example, and Group-C is a public relations group, for example. User-1 and User-2 are specific users. An imaging apparatus related to this content information indicates that temporary access is permitted only at a location where this imaging apparatus is installed.

For example, the content No. D-1 has a content name “joint development process sheets (confidential)” and is stored in a storage location of the content storage 12 identified by “/confidential/joint development/management”. Access to this content is allowed for users belonging to Group-A and Group-B. Temporary access is permitted only at the location where the imaging apparatus C-1 or C-2 is installed.

Likewise, the content No. D-2 has a content name “external design specifications (confidential)” and is stored in a storage location of the content storage 12 identified by “/confidential/joint development/external design specifications”. Access to this content is allowed for users belonging to Group-B and User-1. Temporary access is permitted only at the location where the imaging apparatus C-3 or C-4 is installed. The content No. D-3 has a content name “detailed design specifications (confidential)” and is stored in a storage location of the content storage 12 identified by “/confidential/joint development/detailed design specifications”. Access to this content is allowed for users belonging to Group-B and User-2. Temporary access is permitted only at the location where the imaging apparatus C-3 or C-4 is installed.

In contrast, the content No. D-4 has a content name “exhibition programs” and is stored in a storage location of the content storage 12 identified by “/exhibition”. Access to this content is allowed for users belonging to Group-C. No imaging apparatus 40 is specified to permit temporary access. This means that the location where temporary access can be made to this content is not restricted. Likewise, the content No. D-5 has a content name “exhibition venue construction design drawings” and is stored in a storage location of the content storage 12 identified by “/exhibition”. Access to this content is allowed for users belonging to Group-C. No imaging apparatus 40 is specified to permit temporary access. This means that the location where temporary access can be made to this content is not restricted.

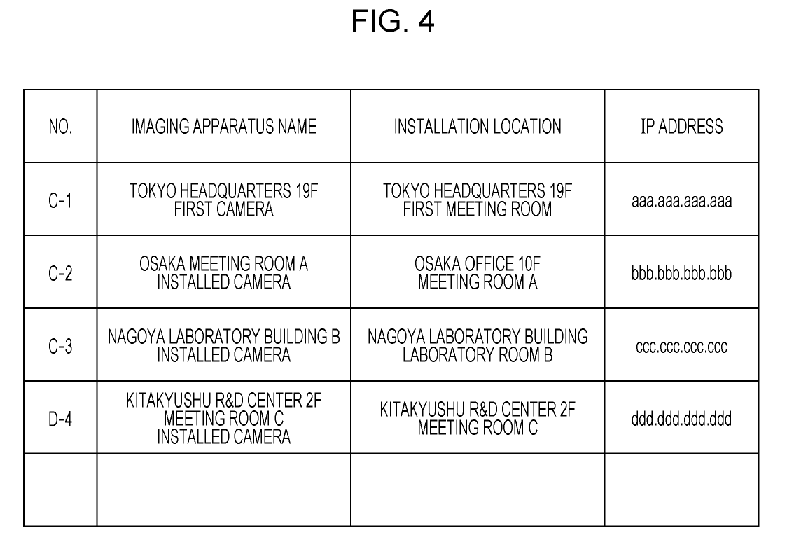

FIG. 4 illustrates an example of imaging apparatus information managed by the access manager 13 of the content management server 10. The access manager 13 stores imaging apparatus information in association with the imaging apparatus number (No.), imaging apparatus name, installation location, and IP address.

For example, concerning the imaging apparatus No. C-1, the imaging apparatus name is “Tokyo headquarters 19F first camera”, the installation location is “Tokyo headquarters 19F first meeting room”, and the IP address is “aaa.aaa.aaa.aaa”. Concerning the imaging apparatus No. C-2, the imaging apparatus name is “Osaka meeting room A installed camera”, the installation location is “Osaka office 10F meeting room A”, and the IP address is “bbb.bbb.bbb.bbb”. Concerning the imaging apparatus No. C-3, the imaging apparatus name is “Nagoya laboratory building B installed camera”, the installation location is “Nagoya laboratory building laboratory room B”, and the IP address is “ccc.ccc.ccc.ccc”. Concerning the imaging apparatus No. C-4, the imaging apparatus name is “Kitakyushu R&D center 2F meeting room C installed camera”, the installation location is “Kitakyushu R&D center 2F meeting room C”, and the IP address is “ddd.ddd.ddd.ddd”.

In this manner, the imaging apparatuses 40 are fixed at predetermined locations. A temporary access request can be made only by an unauthenticated terminal apparatus 30 disposed near the corresponding imaging apparatus 40. The imaging apparatus 40 can be identified by the IP address.

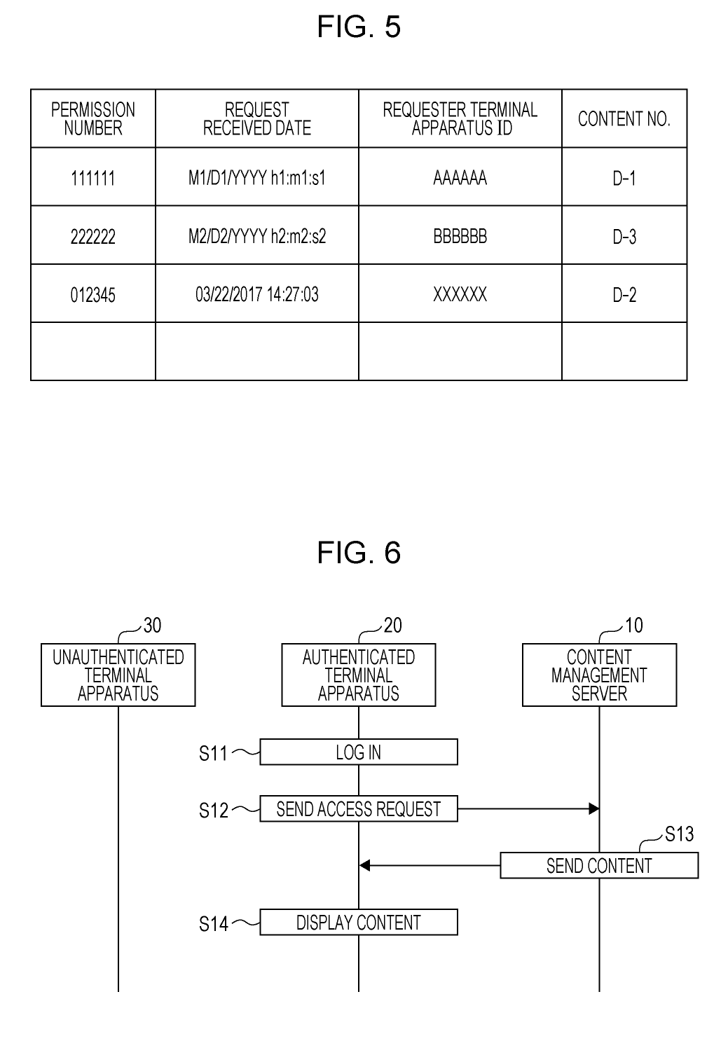

FIG. 5 illustrates an example of temporary access information managed by the access manager 13 of the content management server 10. The access manager 13 stores temporary access information in association with the temporary access permission number (permission number), request received date on which a temporary access request has been received, ID (identification: identifier) of an unauthenticated terminal apparatus 30 that has sent a temporary access request (requester terminal apparatus ID), and content No. to which temporary access has been made. Managing of temporary access information makes it possible to identify when and which content has been opened to which unauthenticated terminal apparatus 30.

For example, concerning the permission number “111111”, the request received date is “M1/D1/YYYY h1:m1:s1”, the requester terminal apparatus ID (unauthenticated terminal apparatus 30) is “AAAAAA”, and the content No. is “D-1”. Concerning the permission number “222222”, the request received date is “M2/D2/YYYY h2:m2:s2”, the requester terminal apparatus ID (unauthenticated terminal apparatus 30) is “BBBBBB”, and the content No. is “D-3”. Concerning the permission number “012345”, the request received date is “03/22/2017 14:27:03”, the requester terminal apparatus ID (unauthenticated terminal apparatus 30) is “XXXXXX”, and the content No. is “D-2”.

### (Operation of Access Control System 1)

The operation of the access control system 1 will be described below.

FIG. 6 is a sequence diagram illustrating an access request made by the authenticated terminal apparatus 20 and a response to this access request returned from the content management server 10, that is, the operation between the content management server 10 and the authenticated terminal apparatus 20. The unauthenticated terminal apparatus 30 is also shown, although it is not related to the operation.

A description will be given, with reference to FIGS. 1 and 6, of a case in which the authenticated terminal apparatus 20 sends the content management server 10 a request to access content managed by the content management server 10.

In step S11, an operator of the authenticated terminal apparatus 20 logs in the authenticated terminal apparatus 20. The concept of “login” is as follows. The access right authenticator 14 of the content management server 10 verifies whether the operator of the authenticated terminal apparatus 20 is authorized to access content managed by the content management server 10. If the operator is found to be an authorized user, the operator is permitted to access the content requested by the operator. The operator of the authenticated terminal apparatus 20 is authenticated as a user authorized to access the content (a user having an access right) as a result of logging in the authenticated terminal apparatus 20. Login operation may be performed by using an ID, an ID and a password, or part of a body, such as a fingerprint or an iris (biometric authentication).

The authenticated terminal apparatus 20 has been authenticated by the content management server 10 in advance. Additionally, the operator of the authenticated terminal apparatus 20 is a manager or a creator of content managed by the content management server 10. Hence, as far as the operator is concerned, security can be guaranteed by performing the above-described authentication. That is, in response to a content access request from the authenticated terminal apparatus 20, authentication is required only for the operator of the authenticated terminal apparatus 20.

After logging in the authenticated terminal apparatus 20, in step S12, the operator sends a request to access the content (access request) to the content management server 10.

Then, in step S13, the content management server 10 sends the requested content to the authenticated terminal apparatus 20.

In step S14, the operator of the authenticated terminal apparatus 20 can access the requested content. If the content is a document, the document is displayed on the display 25 (see FIG. 1) of the authenticated terminal apparatus 20.

After the operator has logged in the authenticated terminal apparatus 20, the content management server 10 may send a list of content pieces (content list) to which the operator is permitted to access to the authenticated terminal apparatus 20. Then, the operator may select a piece of content from the content list and send an access request.

In step S12, the list of content pieces (content list) managed by the content management server 10 may be displayed on the display 25 of the authenticated terminal apparatus 20. Then, when the operator selects a piece of content from the list, the access right authenticator 14 may verify whether the operator has an access right for the selected piece of content.

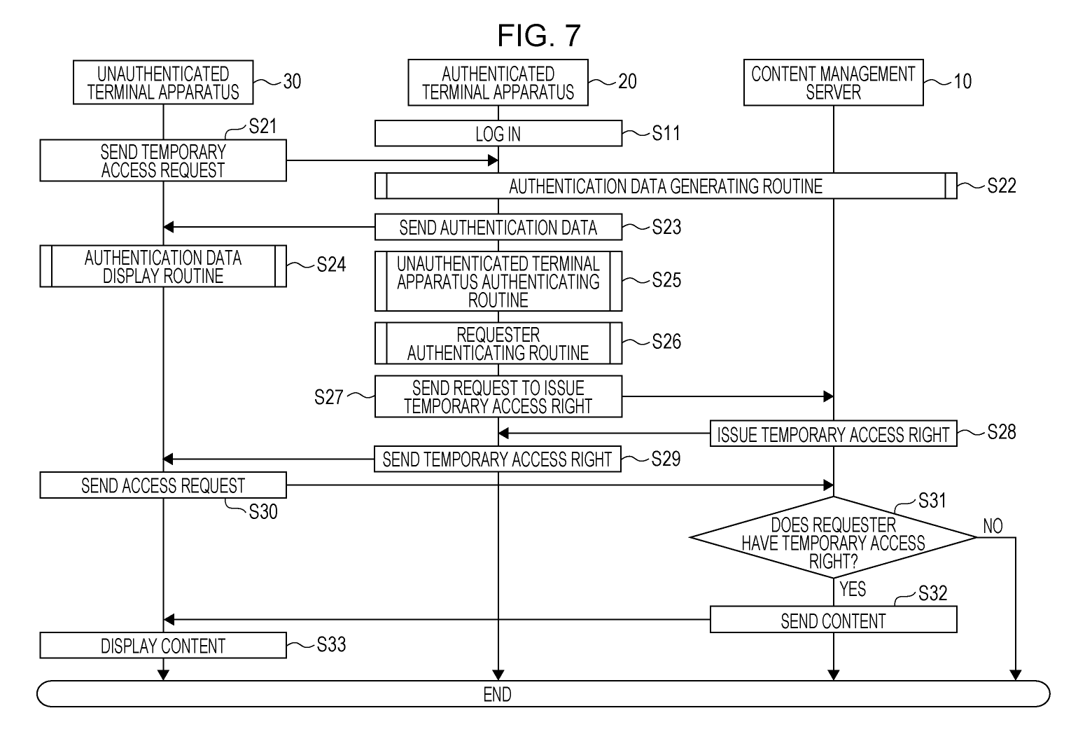

FIG. 7 is a sequence diagram illustrating a temporary access request made by the unauthenticated terminal apparatus 30 and a response to this temporary access request, that is, the operation among the content management server 10, the authenticated terminal apparatus 20, and the unauthenticated terminal apparatus 30. Details of some routines shown in FIG. 7 will be discussed later.

The unauthenticated terminal apparatus 30 is a terminal that makes a request to temporarily access content (temporary access request) as discussed above. As the imaging apparatus 40 discussed with reference to FIG. 4, the unauthenticated terminal apparatus 30 is disposed at a location, such as a meeting room or a laboratory room, where the authenticated terminal apparatus 20 is not positioned, and is used for making a temporary access request.

A description will be given, with reference to FIGS. 1 and 7, of a case in which the unauthenticated terminal apparatus 30 sends a temporary access request to temporarily access content managed by the content management server 10.

As in step S11 of FIG. 6, the operator has logged in the authenticated terminal apparatus 20. That is, the operator is authenticated by the content management server 10 and is permitted to access the content managed by the content management server 10.

In step S21, as a result of a requester making a temporary access request to access the content managed by the content management server 10, the temporary access request generator 32 (see FIG. 1) of the unauthenticated terminal apparatus 30 sends a temporary access request to the authenticated terminal apparatus 20. Then, in step S22, the authentication data generator 22 (see FIG. 1) of the authenticated terminal apparatus 20 executes an authentication data generating routine for generating authentication data for verifying and authenticating the unauthenticated terminal apparatus 30. Then, in step S23, the authenticated terminal apparatus 20 sends the generated authentication data to the unauthenticated terminal apparatus 30.

In step S24, the authentication data representation forming unit 33 (see FIG. 1) of the unauthenticated terminal apparatus 30 executes an authentication data display routine for displaying a representation based on the authentication data received from the authenticated terminal apparatus 20 on the display 35 (see FIG. 1).

The representation based on the authentication data is a representation that can be uniquely identified as the representation based on the authentication data by the authenticated terminal apparatus 20 when an image of the representation of the authentication data is captured by the imaging apparatus 40 and the image is sent to the authenticated terminal apparatus 20. For example, if the authentication data is characters or numbers, the characters or numbers are displayed as a representation based on the authentication data. Alternatively, the characters or numbers may be converted into another format of data based on the authentication data, and the converted data may be displayed as a representation based on the authentication data. Examples of another format of data converted from the authentication data are codes, such as a linear barcode, a two-dimensional barcode, and Quick Response (QR) code (registered trademark), and patterns into which authentication data is embedded. Converting the authentication data in this manner makes the authentication data less recognizable.

In step S25, the authenticator 23 of the authenticated terminal apparatus 20 executes an unauthenticated terminal apparatus authenticating routine for authenticating the unauthenticated terminal apparatus 30.

After the unauthenticated terminal apparatus 30 has been authenticated by the unauthenticated terminal apparatus authenticating routine in step S25, in step S26, the authenticated terminal apparatus 20 executes a requester authenticating routine for authenticating the requester of the temporary access request sent from the unauthenticated terminal apparatus 30.

After the requester of the temporary access request has been authenticated by the requester authenticating routine in step S26, in step S27, the operator of the authenticated terminal apparatus 20 operates the temporary access authorizer 24 to request the content management server 10 to issue a temporary access right. Then, in step S28, the temporary access right issuer 15 of the content management server 10 issues a temporary access right. The temporary access right is then sent to the authenticated terminal apparatus 20.

Operating of the temporary access authorizer 24 by the authenticated terminal apparatus 20 is an operation for granting a temporary access right. The temporary access authorizer 24 is constituted by the input device 108 shown in FIG. 2. As a result of the operator operating the input device 108, a temporary access right is granted. Examples of the input device 108 are a keyboard, a touchscreen, and a switch.

In step S29, the authenticated terminal apparatus 20 sends the temporary access right received from the content management server 10 to the unauthenticated terminal apparatus 30. In step S30, the unauthenticated terminal apparatus 30 sends, together with the received temporary access right, a content access request to the content management server 10. Then, in step S31, the access right authenticator 14 of the content management server 10 judges whether the requester has a temporary access right.

If the access right authenticator 14 has judged that the requester has a temporary access right (YES in step S31), it proceeds to step S32. In step S32, the requested content is read from the content storage 12 of the content management server 10 and is sent to the unauthenticated terminal apparatus 30. The requester is then able to access the requested content. If the requested content is a document, the document is displayed on the display 35 in step S33.

If the access right authenticator 14 has judged that the requester does not have a temporary access right (NO in step S31), the access request is rejected. In this case, information that the access request has been rejected may be supplied to the unauthenticated terminal apparatus 30 and be displayed.

The authentication data generating routine in step S22, the authentication data display routine in step S24, the unauthenticated terminal apparatus authenticating routine in step S25, and the requester authenticating routine in step S26 will be discussed below in detail.

### (Authentication Data Generating Routine)

The authentication data generating routine in step S22 will first be discussed.

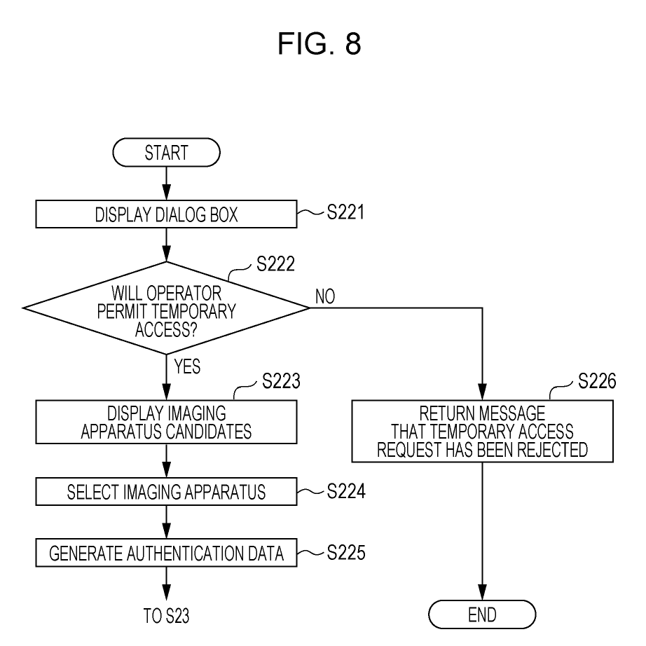

FIG. 8 is a flowchart illustrating an example of the authentication data generating routine. FIG. 8 illustrates the operation of the authenticated terminal apparatus 20 after a temporary access request has been sent from the unauthenticated terminal apparatus 30 (step S21 of FIG. 7). It is assumed that the unauthenticated terminal apparatus 30 has made a temporary access request for the content No. D-2 having the content name “external design specifications (confidential)” shown in FIG. 3.

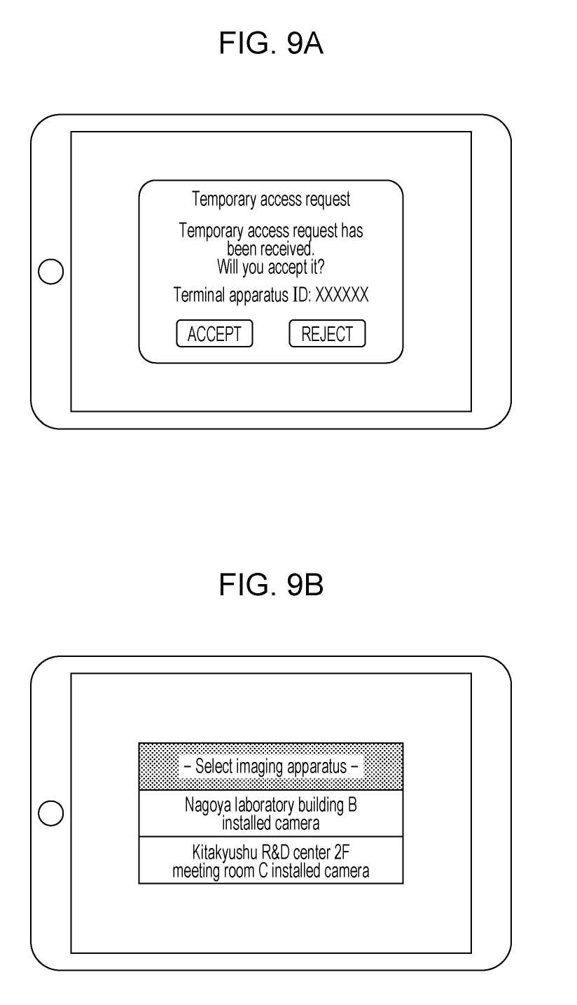

FIGS. 9A and 9B illustrate examples of display screens on the display 25 of the authenticated terminal apparatus 20. FIG. 9A illustrates an example of a dialog box displayed when a temporary access request has been received. FIG. 9B illustrates an example of a dialog box for selecting an imaging apparatus 40. The dialog box is a small window in which a message for prompting an operator to respond and selection buttons, for example, are displayed.

When a temporary access request has been sent from the unauthenticated terminal apparatus 30 (step S21 of FIG. 7), in step S221, the authenticated terminal apparatus 20 displays a dialog box, such as that shown in FIG. 9A, on the display 25. The dialog box in FIG. 9A shows a message that a temporary access request has been received from the unauthenticated terminal apparatus 30 of a terminal apparatus ID XXXXXX. An “accept” button and a “reject” button are also displayed in the dialog box.

In step S222, the operator of the authenticated terminal apparatus 20 judges whether to permit temporary access to the requested content. The operator of the authenticated terminal apparatus 20 is a manager or a creator of the requested content. That is, the operator is authorized to permit temporary access to this content. The operator is now required to share this content with the requester of the temporary access request in a meeting, for example.

If the result of step S222 is YES, that is, if the operator of the authenticated terminal apparatus 20 has selected the “accept” button to permit a temporary access, in step S223, a dialog box, such as that shown in FIG. 9B, is displayed on the display 25 of the authenticated terminal apparatus 20, based on the content information (FIG. 3) managed by the access manager 13 of the content management server 10. FIG. 3 shows that the imaging apparatus No. C-3 and the imaging apparatus No. C-4 are associated with the content No. D-2. FIG. 4 shows that the imaging apparatus No. C-3 has an imaging apparatus name “Nagoya laboratory building B installed camera” and is installed in “Nagoya laboratory building laboratory room B” and that the imaging apparatus No. C-4 has an imaging apparatus name “Kitakyushu R&D center 2F meeting room C installed camera” and is installed in “Kitakyushu R&D center 2F meeting room C”. Accordingly, in the dialog box in FIG. 9B, “Nagoya laboratory building B installed camera” and “Kitakyushu R&D center 2F meeting room C installed camera” are displayed as selection options. That is, the locations where a temporary access can be made are restricted by the locations where these imaging apparatuses 40 are installed.

In step S224, the operator of the authenticated terminal apparatus 20 selects one of the imaging apparatuses 40 in the dialog box shown in FIG. 9B. Then, in step S225, the authentication data generator 22 of the authenticated terminal apparatus 20 generates authentication data.

Then, the authentication data generating routine in step S22 has been completed.

If the result of step S222 is NO, that is, if the operator of the authenticated terminal apparatus 20 has selected the “reject” button to reject a temporary access, a message indicating that the temporary access request has been rejected is returned to the unauthenticated terminal apparatus 30 in step S226.

### (Authentication Data Display Routine)

The authentication data display routine in step S24 will now be described below.

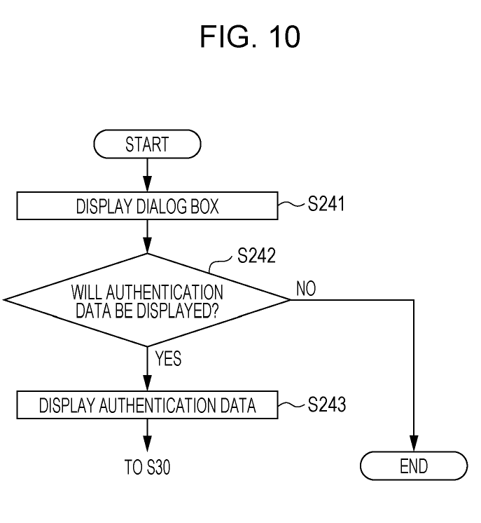

FIG. 10 is a flowchart illustrating an example of the authentication data display routine. FIG. 10 illustrates the operation of the unauthenticated terminal apparatus 30 after authentication data has been sent from the authenticated terminal apparatus 20 to the unauthenticated terminal apparatus 30 (step S23 of FIG. 7).

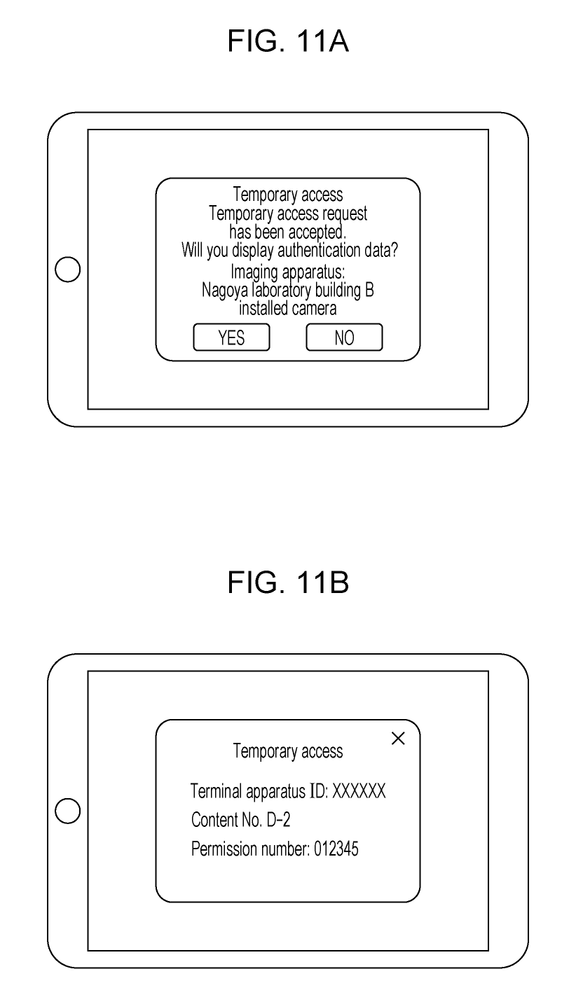

FIGS. 11A and 11B illustrate examples of display screens on the display 35 of the unauthenticated terminal apparatus 30. FIG. 11A illustrates an example of a dialog box displayed when authentication data has been received. FIG. 11B illustrates an example of a representation displayed based on the authentication data.

When the authentication data has been sent from the authenticated terminal apparatus 20 to the unauthenticated terminal apparatus 30 (step S23 of FIG. 7), a dialog box, such as that shown in FIG. 11A, is displayed on the display 35 of the unauthenticated terminal apparatus 30 in step S241. The dialog box in FIG. 11A shows a message that the temporary access request has been accepted and a message for prompting the requester to display the authentication data. In the dialog box, the imaging apparatus 40 to be used for a temporary access (“imaging apparatus: Nagoya laboratory building B installed camera”) and selection buttons (a YES button and a NO button) are also displayed.

In step S242, the requester having sent a temporary access request by using the unauthenticated terminal apparatus 30 judges whether to display the authentication data.

If the result of step S242 is YES, that is, if the requester has selected the “YES” button, in step S243, a dialog box, such as that shown in FIG. 11B, is displayed on the display 35 of the unauthenticated terminal apparatus 30. The dialog box corresponds to a representation based on the authentication data. In the dialog box, the terminal apparatus ID (XXXXXX) of the unauthenticated terminal apparatus 30, the content No. (D-2) for which the temporary access request has been made, and the permission number are displayed.

Then, the authentication data display routine in step S24 has been completed.

If the result of step S242 is NO, that is, if the requester having sent a temporary access request by using the unauthenticated terminal apparatus 30 has selected the “NO” button, the authentication data is not displayed on the display 35 of the unauthenticated terminal apparatus 30. In this case, the unauthenticated terminal apparatus 30 may send a message that the temporary access request has been withdrawn to the authenticated terminal apparatus 20.

This operation enables the authenticated terminal apparatus 20 to easily determine that the received temporary access request has been sent from an unauthenticated terminal apparatus 30 which is not allowed to access the requested content. The authenticated terminal apparatus 20 then does not proceed with any further operation for the temporary access request.

If the requester has selected the “NO” button in the dialog box in FIG. 11A, this means that the imaging apparatus 40 indicated in the dialog box in FIG. 11A is not the imaging apparatus 40 installed near the requester. In this case, the unauthenticated terminal apparatus 30 is not authorized to access the requested content, and the requester is accordingly unable to access the content.

### (Unauthenticated Terminal Apparatus Authenticating Routine)

The unauthenticated terminal apparatus authenticating routine in step S25 will now be described below.

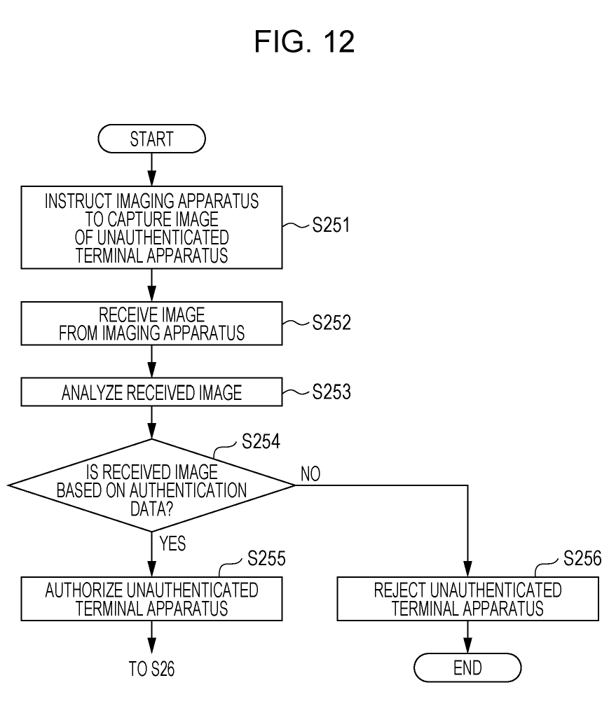

FIG. 12 is a flowchart illustrating an example of the unauthenticated terminal apparatus authenticating routine. FIG. 12 illustrates the operation of the authenticated terminal apparatus 20 after the authentication data has been displayed on the display 35 of the unauthenticated terminal apparatus 30 (step S243 of FIG. 10).

In step S251, the authenticated terminal apparatus 20 instructs the imaging apparatus 40 to capture the image of the authentication data, such as that shown in FIG. 11B, displayed on the display 35 of the unauthenticated terminal apparatus 30. Then, in step S252, the authenticated terminal apparatus 20 receives the image captured by the imaging apparatus 40.

In step S253, the operator of the authenticated terminal apparatus 20 analyzes the received image. Then, in step S254, the operator judges whether the received image is based on the authentication data sent from the authenticated terminal apparatus 20.

If the authentication data has been converted into another format of data, in step S253, the operator of the authenticated terminal apparatus 20 analyzes the image of the converted data received from the imaging apparatus 40 to verify whether the image is a representation that can be uniquely identified as the representation based on the authentication data.

If the result of step S254 is YES, that is, if the image received from the imaging apparatus 40 is based on the authentication data sent from the authenticated terminal apparatus 20, in step S255, the authenticated terminal apparatus 20 permits a temporary access from the unauthenticated terminal apparatus 30 (authorizes the unauthenticated terminal apparatus 30 to access the content).

Then, the unauthenticated terminal apparatus authenticating routine in step S25 has been completed.

If the result of step S254 is NO, that is, if the image received from the imaging apparatus 40 is not based on the authentication data sent from the authenticated terminal apparatus 20, in step S256, the authenticated terminal apparatus 20 rejects a temporary access from the unauthenticated terminal apparatus 30 (rejects the unauthenticated terminal apparatus 30). In this case, the authenticated terminal apparatus 20 may send a message that the temporary access has been rejected to the unauthenticated terminal apparatus 30.

In the above-described operation, analyzing of the image received from the imaging apparatus 40 in step S253 and judging regarding whether the image received from the imaging apparatus 40 is based on the authentication data in step S254 are executed by the operator of the authenticated terminal apparatus 20. Instead of the operator, however, the authenticator 23 of the authenticated terminal apparatus 20 may analyze the received image and make the above-described judgement. In this case, the authenticator 23 displays analyzing results and/or judging results on the display 25 of the authenticated terminal apparatus 20 so as to inform the operator of the results. This is effective when the image received from the imaging apparatus 40 (representation based on the authentication data) is difficult to identify by the operator. Additionally, the authenticator 23 of the authenticated terminal apparatus 20 can analyze the image and make the judgement more precisely in a shorter time than when the operator does.

In step S251, the authenticated terminal apparatus 20 instructs the imaging apparatus 40 to capture the image of a representation based on the authentication data displayed on the display 35 of the unauthenticated terminal apparatus 30. The imaging apparatus 40 may be an apparatus that constantly captures video images. In this case, if the authenticated terminal apparatus 20 is able to identify a representation based on the authentication data displayed on the display 35 from the video images, step S251 may be omitted.

### (Requester Authenticating Routine)

The requester authenticating routine in step S26 will now be described below.

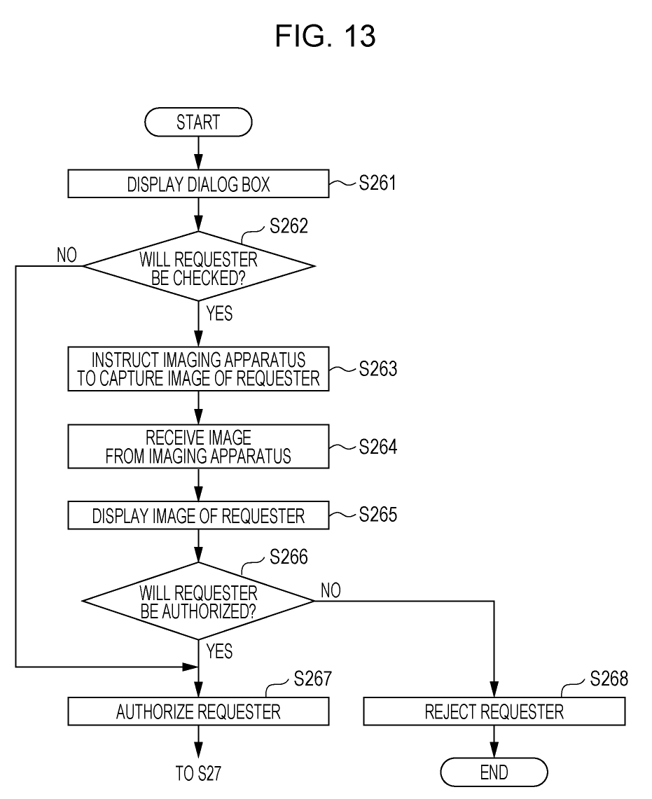

FIG. 13 is a flowchart illustrating an example of the requester authenticating routine. FIG. 13 illustrates the operation of the authenticated terminal apparatus 20 after the unauthenticated terminal apparatus 30 has been authorized by the unauthenticated terminal apparatus authenticating routine in step S25 (step S255 of FIG. 12).

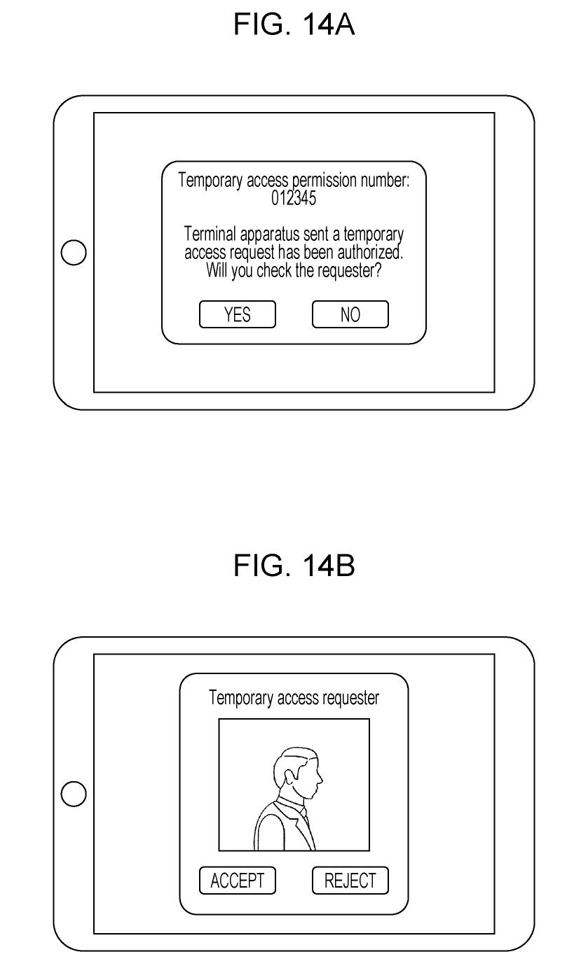

FIGS. 14A and 14B illustrate examples of display screens on the display 25 of the authenticated terminal apparatus 20. FIG. 14A illustrates an example of a dialog box displayed when the unauthenticated terminal apparatus 30 has been authorized. FIG. 14B illustrates an example of a dialog box with an image of the requester of a temporary access request displayed for checking the requester.

In step S261, a dialog box, such as that shown in FIG. 14A, is displayed on the display 25 of the authenticated terminal apparatus 20. The dialog box in FIG. 14A shows information that the unauthenticated terminal apparatus 30 has been authorized and a message for prompting the operator to respond to a question whether to check the requester. The permission number “012345” and selection buttons (a YES button and a NO button) are also displayed in the dialog box.

The operator of the authenticated terminal apparatus 20 judges in step S262 whether to check the requester.

If the result of step S262 is YES, that is, if the operator of the authenticated terminal apparatus 20 has selected the “YES” button, the authenticated terminal apparatus 20 instructs the imaging apparatus 40 to capture the image of the requester in step S263. Then, in step S264, the authenticated terminal apparatus 20 receives (obtains) the image of the requester, such as that shown in FIG. 14B. In step S265, the dialog box with the image shown in FIG. 14B is displayed on the display 25 of the authenticated terminal apparatus 20. In the dialog box in FIG. 14B, an “accept” button and a “reject” button are displayed together with the image of the requester.

In step S266, the operator of the authenticated terminal apparatus 20 judges whether to authorize the requester based on the image of the requester displayed on the display 25 of the authenticated terminal apparatus 20.

If the result of step S266 is YES, that is, if the operator has selected the “accept” button, the requester is authorized in step S267. If the result of step S266 is NO, that is, if the operator has selected the “reject” button, the requester is rejected in step S268. In this case, the authenticated terminal apparatus 20 may send a message that the requester has been rejected to the unauthenticated terminal apparatus 30.

If the result of step S262 is NO, that is, if the operator of the authenticated terminal apparatus 20 has selected the “NO” button, step S267 is executed. This means that the operator authorizes the requester without checking the image of the requester. That is, authentication of the requester based on the image is not required. For example, if security of the installation location of the imaging apparatus 40 which is instructed to capture the image of a representation based on the authentication data is as high as that of the authenticated terminal apparatus 20, authentication of the requester based on the image may not be required. In this manner, authentication of a requester based on an image may be omitted depending on the installation location of the imaging apparatus 40 which is instructed to capture the image of a representation based on authentication data.

In step S263, the authenticated terminal apparatus 20 instructs the imaging apparatus 40 to capture the image of the requester. The imaging apparatus 40 may be an apparatus that constantly capture video images. In this case, if the authenticated terminal apparatus 20 is able to identify the requester from the video images, step S263 may be omitted.

As described above, the unauthenticated terminal apparatus 30 is authenticated, and also, the requester having sent a temporary access request by using the unauthenticated terminal apparatus 30 is authenticated. Authentication of the unauthenticated terminal apparatus 30 is conducted as a result of the imaging apparatus 40 fixed near the unauthenticated terminal apparatus 30 capturing the image of a representation based on authentication data sent from the authenticated terminal apparatus 20. The imaging apparatus 40 is managed by the access manager 13 of the content management server 10. That is, the unauthenticated terminal apparatus 30 is authenticated by using the imaging apparatus 40 managed by the content management server 10. By restricting the terminals that can make a temporary access request, high security is likely to be achieved. If, as well as the imaging apparatus 40, the unauthenticated terminal apparatus 30 is fixed near the imaging apparatus 40, security can further be enhanced.

The operator of the authenticated terminal apparatus 20 visually checks a requester having sent a temporary access request by using the unauthenticated terminal apparatus 30, based on the image captured by the imaging apparatus 40. This makes it easier for the operator to judge whether to accept the temporary access request. If the requester of the unauthenticated terminal apparatus 30 has already been authorized to access content, an ID, an ID and a password, or biometric authentication may be used to guarantee security. However, it is still possible that unauthorized access, such as spoofing, be made.

In contrast, as discussed in the exemplary embodiment, the requester can be identified easily and correctly by visual check, based on the image captured by the imaging apparatus 40. Additionally, it is possible to grant a temporary access right to a user who has not been authenticated in advance, that is, a user whose ID is not registered. In other words, registering of an ID, a password, or data for biometric authentication, such as a fingerprint or an iris, for identifying a user is not necessary.

That is, in this exemplary embodiment, it is possible to easily judge whether to grant a temporary access right to a requester of temporary access to content without the need to register the requester.

### FIRST MODIFIED EXAMPLE

In the above-described exemplary embodiment, the same imaging apparatus 40 is used for capturing the image of a representation based on authentication data displayed on the display 35 of the unauthenticated terminal apparatus 30 and the image of a requester having sent a temporary access request. In this case, it may become necessary to change the direction of the imaging apparatus 40 when capturing the image of a representation based on the authentication data and when capturing the image of a requester. To eliminate such a need, an imaging apparatus for capturing the image of a representation based on the authentication data and an imaging apparatus for capturing the image of a requester may be provided separately. As the imaging apparatus for capturing the image of a representation based on the authentication data, an image reader, such as a scanner, may be used. As the imaging apparatus for capturing the image of a requester, an imaging device (camera) attached to the unauthenticated terminal apparatus 30 may be used. In this case, it is necessary that these imaging apparatuses connect to the authenticated terminal apparatus 20 via the network 50 and operate in response to an instruction from the authenticated terminal apparatus 20.

### SECOND MODIFIED EXAMPLE

In the above-described exemplary embodiment, to enhance security, the imaging apparatus 40 is fixed at a predetermined location. However, the imaging apparatus 40 is registered, but may be mobile. For example, the imaging apparatus 40 may be identified by the registered IP address, as shown in FIG. 4. In this case, the unauthenticated terminal apparatus 30 is authenticated at a location where the imaging apparatus 40 is positioned. The imaging apparatus information shown in FIG. 4 may indicate both of imaging apparatuses 40 fixed at predetermined locations and mobile imaging apparatuses 40.

### THIRD MODIFIED EXAMPLE

In the above-described exemplary embodiment, as shown in FIG. 4, the imaging apparatuses 40 are installed at a meeting room or a laboratory room, for example. Alternatively, the imaging apparatuses 40 may be used as fixed-point observing imaging apparatuses for observing traffic, weather, or crime prevention. These imaging apparatuses 40 are fixed at predetermined locations, and a user may use such an imaging apparatus 40 for conducting authentication, as in the above-described exemplary embodiment.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an authentication data sender that sends authentication data to a subject terminal apparatus, the authentication data being used for granting a temporary access right to temporarily access content;
an authenticator that authenticates the subject terminal apparatus by using a representation based on the authentication data displayed on the subject terminal apparatus;
a display that displays an image of a user of the subject terminal apparatus, the image being obtained by using an imaging apparatus to which the information processing apparatus is connectable via a network; and
an operation receiver that receives an operation performed by an operator of the information processing apparatus to grant the temporary access right.

2. The information processing apparatus according to claim 1, wherein the authenticator authenticates the subject terminal apparatus by analyzing the representation based on the authentication data.

3. The information processing apparatus according to claim 2, wherein the representation based on the authentication data analyzed by the authenticator is an image based on the authentication data.

4. The information processing apparatus according to claim 1, wherein the imaging apparatus is a registered imaging apparatus.

5. The information processing apparatus according to claim 4, wherein the imaging apparatus has been selected when the authentication data is sent from the authentication data sender to the subject terminal apparatus.

6. An access control system comprising:
a first terminal apparatus having an access right to access content; and
an imaging apparatus that is connected to the first terminal apparatus via a network and is capable of capturing an image of a user of a second terminal apparatus which does not have the access right,
the first terminal apparatus including
an authentication data sender that sends authentication data to the second terminal apparatus in response to a request from the second terminal apparatus, the authentication data being used for granting a temporary access right to temporarily access the content,
an authenticator that authenticates the second terminal apparatus by using a representation based on the authentication data displayed on the second terminal apparatus,
a display that displays an image obtained by the imaging apparatus, and
an operation receiver that receives an operation performed by an operator of the first terminal apparatus to grant the temporary access right.

7. The access control system according to claim 6, wherein the imaging apparatus captures an image of the representation based on the authentication data displayed on the second terminal apparatus and sends the image to the first terminal apparatus.

8. The access control system according to claim 7, wherein the imaging apparatus is fixed at a predetermined location.

9. The access control system according to claim 8, wherein authenticating of the user of the second terminal apparatus based on an image of the user is not conducted, depending on the location of the imaging apparatus which has been instructed to capture the image of the representation based on the authentication data.

10. A non-transitory computer readable medium storing a program causing a computer to execute a process, the process comprising:
sending authentication data to a subject terminal apparatus, the authentication data being used for granting a temporary access right to temporarily access content;
authenticating the subject terminal apparatus by using a representation based on the authentication data displayed on the subject terminal apparatus;
displaying an image of a user of the subject terminal apparatus, the image being obtained by using an imaging apparatus to which an information processing apparatus is connectable via a network; and
receiving an operation performed by an operator of the information processing apparatus to grant the temporary access right.
